(19) United States
(12) Patent Application Publication
(10) Pub. No.: US 2011/0138999 A1
(43) Pub. Date: Jun. 16, 2011

(54) METAL ORGANIC FRAMEWORK POLYMER MIXED MATRIX MEMBRANES

(75) Inventor: Richard R. Willis, Cary, IL (US)

(73) Assignee: UOP LLC, Des Plaines, IL (US)

(21) Appl. No.: 12/942,530

(22) Filed: Nov. 9, 2010

Related U.S. Application Data
(60) Provisional application No. 61/286,435, filed on Dec. 15, 2009.

(51) Int. Cl. B01D 53/22; B29C 39/00

(52) U.S. Cl. 95/45; 264/232

(57) ABSTRACT

Metal-organic framework (MOF)-polymer mixed matrix membranes (MOF-MMMs) can be prepared by dispersing high surface area MOFs into a polymer matrix. The MOFs allow the polymer to infiltrate the pores of the MOFs, which improves the interfacial and mechanical properties of the polymer and in turn affects permeability. These mixed matrix membranes are attractive candidates for practical gas separation applications such as CO₂ removal from natural gas.

### CROSS-REFERENCE TO RELATED APPLICATION

This application claims priority from Provisional Application No. 61/286,435 filed Dec. 15, 2009, the contents of which are hereby incorporated by reference.

### BACKGROUND OF THE INVENTION

This invention relates to the use of metal organic frameworks (MOFs) in mixed matrix membranes. More particularly, this invention relates to the use of a particular set of MOFs that provide enhanced separation of gases including the separation of carbon dioxide from methane.

Gas separation processes with membranes have undergone a major evolution since the introduction of the first membrane-based industrial hydrogen separation process about two decades ago. The design of new materials and efficient methods will further advance the membrane gas separation processes within the next decade.

The gas transport properties of many glassy and rubbery polymers have been measured, driven by the search for materials with high permeability and high selectivity for potential use as gas separation membranes. Unfortunately, an important limitation in the development of new membranes for gas separation applications is a well-known trade-off between permeability and selectivity. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties, current polymeric membrane materials have seemingly reached a limit in the tradeoff between productivity and selectivity. For example, many polyimide and polyetherimide glassy polymers such as Ultem 1000 have much higher intrinsic CO₂/CH₄ selectivities (α_{CO2/CH4})(˜30 at 50° C. and 100 psig) than that of cellulose acetate (˜22), which are more attractive for practical gas separation applications. These polymers, however, do not have outstanding permeabilities attractive for commercialization compared to current commercial cellulose acetate membrane products, in agreement with the trade-off relationship reported by Robeson.

To enhance membrane selectivity and permeability, mixed matrix membranes (MMMs) have been developed in recent years. To date, almost all of the MMMs reported in the literature are hybrid blend membranes comprising insoluble solid domains such as molecular sieves or carbon molecular sieves embedded in a polymer matrix. For example, see U.S. Pat. No. 6,626,980; U.S. Pat. No. 7,109,140; U.S. Pat. No. 7,268,094; U.S. Pat. No. 6,562,110; U.S. Pat. No. 6,755,900; U.S. Pat. No. 6,500,233; U.S. Pat. No. 6,503,295 and U.S. Pat. No. 6,508,860. These MMMs combine the low cost and easy processability of the polymer with the superior gas separation properties provided by the molecular sieve. These membranes have the potential to achieve higher selectivity with equal or greater permeability compared to existing polymer membranes, while maintaining their advantages. In contrast to the many studies on conventional polymers for membranes, only a few attempts to increase gas separation membrane performance with MMMs of zeolite and rubbery or glassy polymers have been reported. These MMMs have shown some promise, but there remains a need for improved membranes that combine the desired higher selectivity and permeability goals previously discussed.

In the present invention, it has been found that a new type of metal-organic framework (MOF)-polymer or metal-organic polyhedra (MOP)-polymer MMM achieves significantly enhanced gas separation performance (higher α_{CO}_{₂}_{^{/CH}}_{₄}) compared to that of cellulose acetate membranes.

These MOFs and similar structures were recently reported. Simard et al. reported the synthesis of an “organic zeolite”, in which rigid organic units are assembled into a microporous, crystalline structure by hydrogen bonds. See Simard et al., J. AM. CHEM. SOC., 113:4696 (1991). Yaghi and co-workers and others have reported a new type of highly porous crystalline zeolite-like materials termed “metal-organic frameworks” (MOFs). These MOFs are composed of ordered arrays of rigid organic units connected to metal centers by metal-ligand bonds and they possess vast accessible surface areas. See Yaghi et al., SCIENCE, 295: 469 (2002). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5,but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. These MOF, IR-MOF and MOP materials exhibit analogous behaviour to that of conventional microporous materials such as large and accessible surface areas, interconnected intrinsic micropores. Moreover, they also can possibly reduce the hydrocarbon fouling problem of the polyimide membranes due to the presence of pore sizes larger than those of zeolite materials. MOF, IR-MOF and MOP materials are also expected to allow the polymer to infiltrate the pores, which would improve the interfacial and mechanical properties and would in turn affect permeability. These MOF, IR-MOF and MOP materials are selected as the fillers in the preparation of new MMMs in this invention.

### SUMMARY OF THE INVENTION

The present invention describes the design and preparation of a new class of metal- organic framework (MOF)-polymer MMMs containing high surface area MOF (or IRMOF or MOP, all referred to as “MOF” herein) as fillers. These MMMs incorporate the MOF fillers possessing micro- or meso-pores into a continuous polymer matrix. The MOF fillers have highly porous crystalline zeolite-like structures and exhibit behaviour analogous to that of conventional microporous materials such as large and accessible surface areas and interconnected intrinsic micropores. Moreover, these MOF fillers may reduce the hydrocarbon fouling problem of the polyimide membranes due to their relatively larger pore sizes compared to those of zeolite materials. The polymer matrix can be selected from all kinds of glassy polymers such as polyimides (e.g., Matrimid 5218 sold by Ciba Geigy), polyetherimides (e.g., Ultem 1000 sold by General Electric), cellulose acetates, polysulfone, and polyethersulfone. These MOF-polymer MMMs combine the properties of both the continuous polymer matrix and the dispersed MOF fillers. Pure gas separation experiments on these MMMs show dramatically enhanced gas separation permeability performance for CO₂ removal from natural gas (i.e., 2-3 orders of magnitude higher permeability than that of the continuous Matrimid 5218 polymer matrix without a loss of CO₂ over CH₄ selectivity). These separation results suggest that these new membranes are attractive candidates for practical gas separation applications such as CO₂ removal from natural gas.

### DETAILED DESCRIPTION OF THE INVENTION

A new family of MMMs containing particular types of microporous solid materials as fillers has now been developed that retains its polymer processability with improved selectivity for gas separation due to the superior molecular sieving and sorption properties of the microporous materials. The fillers used herein are MOFs and related structures.

More particularly, the present invention pertains to MOF-polymer MMMs (or MOF-polymer mixed matrix films) containing high surface area MOF materials as fillers. These new MMMs have application for the separation of a variety of gas mixtures. One such separation that has significant commercial importance is the removal of carbon dioxide from natural gas. MMMs permit carbon dioxide to diffuse through such membranes at a faster rate than methane. Carbon dioxide has a higher permeation rate than methane because of higher solubility in the membrane, higher diffusivity, or both. Thus, the concentration of carbon dioxide enriches on the permeate side of the membrane, while methane enriches on the feed (or reject) side of the membrane.

The MOF-polymer MMMs developed in this invention have MOF fillers dispersed throughout a continuous polymer phase. The resulting membrane has a steady-state permeability different from that of the pure polymer due to the combination of the molecular sieving and sorption gas separation mechanism of the MOF filler phase with the solution-diffusion gas separation mechanism of the polymer matrix phase.

Design of the MOF-polymer MMMs containing micro- or meso-porous MOF fillers described herein is based upon the proper selection of both MOF filler and the continuous polymer matrix. Material selection for both MOF filler and the continuous polymer matrix is a key aspect for the preparation of MOF-polymer MMMs with excellent gas separation properties.

The MOFs that are used typically comprise a transition metal and one or two linkers of various types. The transition metals are most often first-row transition metals (i.e., Zn, Cu, Ni, Co, Fe, Mn, Cr, V), but can also be second-row transition metals such as Cd, lanthanides such as Er and Yb, or alkaline earth metals such as Mg. The linkers are quite varied, and can range from mono-, bi- and tri-carboxylates (such as formate, 1,4-benzenedicarboylate (BDC), and 4,4′,4″-S-triazine-2,4,6-triyl tribenzoate (TATB) to bipyridyls (such as 4,4′-bipyridine, bipy). Some linkers have combined functionalities, such as combined amine and tetrazole (such as 4-aminophenyl-1H-tetrazole), combined bipyridyl and tetrazole (such as 2,3-di-1H-tetrazol-5-ylpyrazine (H2dtp)), or a combined dicarboxylic acid and pyridyl linker (such as 2,4-pyridinedicarboxylate).

The structures can be 0, 1, or 2 dimensional (with respect to the metal oxide coordination. Under this point of view, this means that the MOF IRMOF-1 is zero-dimensional because all metal oxides are held together by linkers. Other examples include a zero dimensional example is PCN-13, a one-dimensional example is ErPDA, and a two-dimensional example is MOF-508. These MOFs are prepared in accordance with the knowledge of one skilled in the art.

The MOF structures can be open (e.g., Cu-pymo-F), interpenetrated (same framework offset by ˜one-half in three dimensions from a reference framework) such as in PCN-17, interwoven (same framework offset by only a small amount in three dimensions from a reference framework) such as in Nibpe or interdigitated (same layered framework offset in two dimensions from reference framework) such as in CID-1.

The selectivity advantage is typically a molecular sieving effect as most of these MOFs possess pore sizes intermediate between nitrogen (3.64 Å kinetic diameter) and CO2 (3.30 Å kinetic diameter). The pore size range for the examples provided here is about 3 to 5 Å.

Some of these MOFs (e.g., ErPDA and Cu-pymo-F) have exposed or coordinatively unsaturated metal sites. These sites might promote CO2 over nitrogen selectivity.

The MOFs that are preferably used in the present invention include ErPDA, Mn-formate, MgNDC, CUK-1, CID-1, Cd-aptz, PCN-13, Cu₂(BF₄)₂(Bpy), Ni-bpe, ICP, PCN-17, ZnBIPY (bae), ZnDTP, Zn₂(CNC)₂dpt, Cu-pymo-F and MOF-508.

The surface areas for these MOFs are typically low, and cannot be measured with nitrogen as a probe molecule. The range of measured surface areas is from about 100 to 1000 square meters per gram. The MOFs at the upper end of this range tend to have larger pores and are somewhat less selective than those with lower surface areas.

Polymers provide a wide range of properties important for separations, and modifying them can improve membrane selectivity. A material with a high glass transition temperature (T_{g}), high melting point, and high crystallinity is preferred for most gas separations. Glassy polymers (i.e., polymers below their T_{g}) have stiffer polymer backbones and therefore allow smaller molecules such as hydrogen and helium to permeate the membrane more quickly and larger molecules such as hydrocarbons to permeate the membrane more slowly.

For MOF-polymer MMM applications, it is preferred that the membrane fabricated from the pure polymer, which can be used as the continuous polymer phase in the MMMs, exhibit a carbon dioxide or hydrogen over methane selectivity of at least about 15, more preferably the selectivities are at least about 30.Preferably, the polymer used as the continuous polymer phase in the MOF-polymer MMM is a rigid, glassy polymer.

Typical polymers suitable for MOF-polymer MMM preparation as the continuous polymer phase according to the invention are selected from the group consisting of polysulfones; polystyrenes, including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyrate, cellulose propionate, ethyl cellulose, methyl cellulose, nitrocellulose, etc.; polyimides, polyetherimides, and polyamides, including aryl polyamides, aryl polyimides such as Matrimid 5218 and P-84, aryl polyetherimides such as Ultem 1000; polyethers; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polysulfides; polymers from monomers having alpha-olefinic unsaturation other than mentioned above such as poly (ethylene), poly(propylene), poly(butene-1),poly(4-methyl pentene-1),polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly (benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acyl groups and the like.

In the practice of the present invention, microporous materials are defined as solids that contain interconnected pores of less than 2 nm in size and consequently, they possess large and accessible surface areas-typically 300-1500 m²g⁻¹ as measured by gas adsorption. The discrete porosity provides molecular sieving properties to these materials which have found wide applications as catalysts and sorption media.

The MOFs used in the present invention are composed of rigid organic units assembled by metal-ligand bonding and possessing relatively vast accessible surface areas. MOF-5 is a prototype of a new class of porous materials constructed from octahedral Zn—O—C clusters and benzene links. Most recently, the systematic design and construction of a series of frameworks (IRMOF) that have structures based on the skeleton of MOF-5 has been reported, wherein the pore functionality and size have been varied without changing the original cubic topology. For example, IRMOF-1 (Zn₄O(R₁-BDC)₃) has the same topology as that of MOF-5,but was synthesized by a simplified method. In 2001, a porous metal-organic polyhedron (MOP) Cu₂₄(m BDC)₂₄(DMF)₁₄(H2O)₅₀(DMF)₆ (C₂H₅OH)₆, termed “α-MOP-1” and constructed from 12 paddle-wheel units bridged by m-BDC to give a large metal-carboxylate polyhedron. These MOF, IR-MOF and MOP materials exhibit behaviour analogous to that of conventional microporous materials such as large and accessible surface areas, and interconnected intrinsic micropores. Moreover, they may reduce the hydrocarbon fouling problem of the polyimide membranes due to the pore sizes that are relatively larger than those of zeolite materials. MOF, IR-MOF and MOP materials are also expected to allow the polymer to infiltrate the pores, which would improve the interfacial and mechanical properties and would in turn affect permeability.

Therefore, these MOF, IR-MOF and MOP materials (all termed “MOF” herein this invention) are selected as the fillers in the preparation of new MMMs here in this invention. These MOFs, or metal-organic framework materials have very high surface areas per unit volumes, and have very high porosities. MOFs are a new type of porous materials which have a crystalline structure comprising repeating units having a metal or metal oxide with a positive charge and organic units having a balancing counter charge. MOFs provide for pore sizes that can be controlled with the choice of organic structural unit, where larger organic structural units can provide for larger pore sizes. The characteristics for a given gas mixture is dependent on the materials in the MOF, as well as the size of the pores created. Structures and building units for MOFs can be found in US 2005/0192175 A1 published on Sep. 1, 2005 and WO 02/088148 A1 published on Nov. 7, 2002, both of which are incorporated by reference in their entireties.

The materials of use for the present invention include MOFs with a plurality of metal, metal oxide, metal cluster or metal oxide cluster building units, hereinafter referred to as metal building units, where the metal is selected from the transition metals in the periodic table, and beryllium. Preferred metals include zinc (Zn), cadmium (Cd), mercury (Hg), and beryllium (Be). The metal building units are linked by organic compounds to form a porous structure, where the organic compounds for linking the adjacent metal building units include 1,3,5-benzenetribenzoate (BTB); 1,4-benzenedicarboxylate (BDC); cyclobutyl 1,4-benzenedicarboxylate (CB BDC); 2-amino 1,4 benzenedicarboxylate (H2N BDC); tetrahydropyrene 2,7-dicarboxylate (HPDC); terphenyl dicarboxylate (TPDC); 2,6 naphthalene dicarboxylate (2,6-NDC); pyrene 2,7-dicarboxylate (PDC); biphenyl dicarboxylate (BDC); or any dicarboxylate having phenyl compounds.

1. A process for separating at least one gas from a mixture of gases, the process comprising:
a) providing a mixed matrix gas separation membrane comprising a metal organic framework (MOF) material dispersed in a continuous phase consisting essentially of a polymer which is permeable to said at least one gas wherein said MOF comprises a pore size sufficient to exclude molecules having a larger diameter than carbon dioxide from passing through pores within said MOF;
b) contacting the mixture on one side of the mixed matrix membrane to cause said at least one gas to permeate the mixed matrix membrane; and
c) removing from the opposite side of the membrane a permeate gas composition comprising a portion of said at least one gas which permeated said membrane.

2. The process of claim 1 wherein said MOF comprises a systematically formed metal-organic framework comprising one or more transition metal selected from the group consisting of Zn, Cu, Ni, Co, Fe, Mn, Cr, V, lanthanides and alkaline earth metals.

3. The process of claim 1 wherein said MOF comprises at least one linker selected from the group consisting of mono, bi- and tri-carboxylates and bipyridyls.

4. The process of claim 1 wherein said MOF comprises at least one type of linker having combined functionalities selected from the group of combined amine and tetrazole, combined bipyridyl and tetrazole and combined dicarboxylic acid and pyridyl linker.

5. The process of claim 1 wherein said MOF has a structure selected from the group consisting of one, two and three dimensional structures.

6. The process of claim 2 wherein the MOFs are selected from the group consisting of ErPDA, Mn-formate, MgNDC, CUK-1, CID-1, Cd-aptz, PCN-13,Cu₂(BF₄)₂(Bpy), Ni-bpe, ICP, PCN-17, ZnBIPY (bae), ZnDTP, Zn₂(CNC)₂dpt, Cu-pymo-F and MOF-508.

7. The process of claim 1 wherein said continuous phase comprises one or more polymers selected from the group consisting of polysulfones; poly(styrenes), styrene-containing copolymers, polycarbonates; cellulosic polymers, polyimides, polyetherimides, and polyamides, aryl polyamides, aryl polyimides, aryl polyetherimides; polyethers; poly(arylene oxides); poly(esteramide-diisocyanate); polyurethanes; polyesters, polysulfides; poly (ethylene), poly(propylene), poly(butene-1), poly(4-methyl pentene-1), polyvinyls, polyallyls; poly(benzobenzimidazole); polyhydrazides; polyoxadiazoles; polytriazoles; poly (benzimidazole); polycarbodiimides; polyphosphazines; etc., and interpolymers, including block interpolymers containing repeating units from the above polymers.

8. The process of claim 6 wherein said continuous phase comprises one or more polymers selected from the group consisting of polyimides, polyetherimides, and polyamides.

9. The process of claim 1 wherein said mixture of gases comprises a pair of gases selected from the group consisting of hydrogen/methane, carbon dioxide/methane, carbon dioxide/nitrogen, oxygen/nitrogen, methane/nitrogen and olefin/paraffin.

10. A mixed matrix membrane comprising a continuous phase organic polymer and an MOF dispersed in said continuous phase organic polymer.

11. The mixed matrix membrane of claim 10 wherein said MOF comprises a systematically formed metal-organic framework having a plurality of metal, metal oxide, metal cluster or metal oxide cluster building units, and an organic compound linking adjacent building units, wherein the linking compound comprises a linear dicarboxylate having at least one substituted phenyl group.

12. A process for preparation of a mixed matrix membrane comprising:
a) forming a polymer solution by mixing a polymer selected from the group consisting of polysulfones; poly(styrenes), styrene-containing copolymers, polycarbonates; cellulosic polymers, polyimides, polyetherimides, and polyamides, aryl polyamides, aryl polyimides, aryl polyetherimides; polyethers; poly(arylene oxides); poly(esteramide-diisocyanate); polyurethanes; polyesters, polysulfides; poly (ethylene), poly(propylene), poly(butene-1), poly(4-methyl pentene-1), polyvinyls, polyallyls; poly(benzobenzimidazole); polyhydrazides; polyoxadiazoles; polytriazoles; poly (benzimidazole); polycarbodiimides; polyphosphazines; etc., and interpolymers, including block interpolymers containing repeating units from the above polymers with a solvent;
b) forming an MOF-polymer slurry by mixing said polymer solution with at least one MOF comprising a systematically formed metal-organic framework having a plurality of metal, metal oxide, metal cluster or metal oxide cluster building units, and an organic compound linking adjacent building units, wherein the linking compound comprises a linear dicarboxylate having at least one substituted phenyl group and wherein said MOF comprises a pore size sufficient to exclude molecules having a larger diameter than carbon dioxide from passing through pores within said MOF; and
c) casting said MOF-polymer slurry as a thin layer upon a substrate followed by evaporating the solvents in the thin layer, or followed by evaporating the solvents in the thin layer and then immersing the thin layer into a coagulation bath to form an MOF-polymer mixed matrix membrane.

13. The process of claim 12 wherein said polymer is selected from the group consisting of polyimides, polyetherimides, and polyamides.
